(19) United States
(12) Patent Application Publication
(10) Pub. No.: US 2026/0307065 A1
(43) Pub. Date: Oct. 8, 2026

(54) CATALYTIC ARTICLE COMPRISING VANADIUM-CONTAINING CATALYST AND OXIDATION CATALYST

(71) Applicant: BASF CORPORATION, Florham Park, NJ (US)

(72) Inventors: Liang CHEN, Shanghai (CN); Yuchao ZHANG, Shanghai (CN); Renjie QIU, Shanghai (CN); Jiadi ZHANG, Shanghai (CN)

(21) Appl. No.: 18/996,632

(22) PCT Filed: Jul. 18, 2023
(86) PCT No.: PCT/CN2023/107932

§ 371 Date: Jan. 17, 2025

(30) Foreign Application Priority Data
Jul. 19, 2022 (WO) PCT/CN2022/106492

(51) Int. Cl. B01J 29/76; B01D 53/94; B01J 23/22

(52) U.S. Cl. CPC B01J 29/763; B01D 53/945; B01J 23/22; B01D 2255/102; B01D 2255/20723; B01D 2255/2098; B01D 2255/50; B01D 2255/9022; B01D 2257/406; B01D 2258/012

(57) ABSTRACT

The present invention relates to a catalytic article for treating an exhaust stream, comprising a first catalyst containing a vanadium component and an antimony component, and a second catalyst containing a precious metal component, and also to a method and a system for treating an exhaust stream containing nitrogen oxides.

### FIELD OF THE INVENTION

The present invention relates to a catalytic article for treating an exhaust stream containing nitrogen oxides, which comprises a vanadium-containing catalyst and an oxidation catalyst. The present invention also relates to a method and a system for treating an exhaust stream containing nitrogen oxides.

### BACKGROUND

Engine exhaust substantially consists of particulate matter and gaseous pollutants such as unburned hydrocarbons (HC), carbon monoxide (CO) and nitrogen oxides (NOx). The engine exhaust needs to be treated with an engine exhaust system before emission to air. Control of NOx emission is always one of the most important topics for exhaust treatment, particularly for diesel engines, due to the environmentally negative impact of NOx on ecosystem, human beings, animals and plants.

Various treatment processes, for example catalytic reduction of nitrogen oxides, have been used to abate NOx in exhaust gases. One typical catalytic reduction process is selective catalytic reduction with ammonia (NH₃) or ammonia precursor as a reducing agent in the presence of atmospheric oxygen, which is also referred to as SCR process. The SCR process is considered superior since a high degree of NOx abatement can be obtained with a small amount of reducing agent. Typically, the nitrogen oxides and the reducing agent NH₃ are reacted in accordance with following equations:

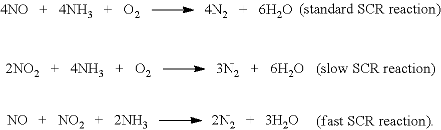

In the SCR process, a stoichiometric excess of the reducing agent NH₃ or precursor thereof is usually dosed into the exhaust stream to abate NOx in a conversion as high as possible. The excess ammonia may exit the tailpipe of an automobile. Another potential scenario where ammonia may exit the tailpipe is desorption of a considerable amount of ammonia, which has been retained on the surface of a SCR catalyst during low temperature portions of a typical driving cycle, from the SCR catalyst when the operation temperature increases. A number of problems will arise if release of ammonia into air occurs, which is also referred to as ammonia slip. Ammonia slip is detrimental to human's health and to the environment. It was known that ammonia may cause noticeable eye and throat irritation above 100 ppm, noticeable skin irritation above 400 ppm, and the IDLH value of ammonia is 500 ppm in air. In addition, ammonia is caustic, especially in its aqueous form. Condensation of ammonia and water in cooler regions of the exhaust line downstream of exhaust treatment catalysts will result in a corrosive mixture, damaging to the exhaust line. Ammonia should be eliminated before passing into the tailpipe. An ammonia oxidation (AMOx) catalyst (also known as ammonia slip catalyst (ASC)) installed downstream of a SCR catalyst is generally used to convert the slipped ammonia into N₂.

Ammonia oxidation (AMOx) catalysts are known, which comprise a precious metal active species for oxidizing ammonia, and usually also comprise an SCR active species. As known SCR active species, zeolites are widely used while vanadium-based species is seldom applied due to the significant poisoning effect of vanadium species on precious metals.

US 2014/0212350A1 describes a catalytic article for treating an emission gas which comprises (a) a first catalyst layer having a plurality of consecutive sub-layers, wherein each sub-layer includes vanadium oxide on a first refractory metal oxide support; (b) a second catalyst layer comprising one or more noble metals disposed on a second refractory metal oxide support; and (c) a substrate, wherein the first and second catalyst layers are on and/or within the substrate. The catalytic article in Examples of the patent application comprises vanadia and tungsten oxide in the first catalyst layer.

WO 2011/140251A2 describes an integrated SCR and AMOx catalyst system which comprises a first zone to abate nitrogen oxides by selective catalytic reduction, a second zone to oxidize ammonia and a third zone to oxidize carbon monoxide and hydrocarbons. The second zone is resulted from overlapping a first catalyst coating comprising a platinum group metal extending from outlet end toward inlet end of a substrate and a second catalyst coating comprising an SCR catalyst extending from the inlet end toward outlet end of the substrate. The SCR catalyst may comprise V₂O₅ and WO₃ supported on TiO₂.

WO 2018/178627A1 describes a catalytic article for treating a flow of a combustion exhaust gas which comprises a substrate formed of an extruded vanadium-containing SCR catalyst material, a first layer provided on at least a portion of the substrate and a second layer provided on at least a portion of the first layer, wherein the first layer comprises an ammonia slip catalyst composition comprising one or more platinum group metals, and the second layer comprises an SCR catalyst composition. A preferred substrate is formed of a blend of vanadium/tungsten/titania and an iron-promoted ZSM-5 zeolite.

It will be desirable if low-cost vanadium-based SCR active species can be applied in ammonia oxidation (AMOx) catalysts with less or no poisoning effect on the precious metal.

### SUMMARY OF THE INVENTION

It is an object of the present invention to provide an AMOx catalytic article comprising a vanadium-based SCR catalyst and a precious metal based catalyst, which will undergo alleviated poisoning of precious metal species and thus can provide improved NH₃ conversion, especially at the low temperature operation phase of an exhaust treatment system.

Surprisingly, the object was achieved by a catalytic article which comprises an SCR catalyst containing vanadium and antimony.

Accordingly, in the first aspect, the present invention relates to a catalytic article for treating an exhaust stream, which comprises
a first catalyst containing a vanadium component and an antimony component, and
a second catalyst containing a precious metal component.

In the second aspect, the present invention relates to a system for treating an exhaust stream, which comprises a reductant source (e.g., NH₃ or a precursor thereof), the catalytic article as described herein, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

In the third aspect, the present invention relates to a method for treatment of an exhaust stream containing nitrogen oxides, which comprises contacting the exhaust stream with the catalytic article as described herein or passing the exhaust stream through the system as described herein, in the presence of NH₃ as a reductant.

In the fourth aspect, the present invention relates to a method for alleviating poisoning of a precious metal component in a catalytic article comprising a vanadium-based catalyst and a precious metal based catalyst, which comprises incorporating an antimony component in the vanadium-based catalyst.

It has been surprisingly found by the inventors that the poisoning of a precious metal component in an AMOx catalytic article comprising a vanadium-based catalyst and a precious metal based catalyst can be effectively suppressed by incorporating an antimony component into the vanadium-based catalyst.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

The term “region” as used herein is just intended to mean a part of the catalytic article which comprises specified materials and extends a certain length in the exhaust stream flow direction.

Herein, any reference to “upstream” and “downstream” will be understood to be relative positions with respect to a stream flow direction, for example flow direction of an exhaust stream.

The terms “first catalyst” and “second catalyst” by themselves are not intended to impose any limitations to the arrangement or configuration way of the two catalysts in the catalytic article. It will be understood that the first catalyst may be arranged either upstream or downstream the second catalyst, either above or underneath the second catalyst, if the two catalysts are separated from each other. It will also be understood that the first catalyst and the second catalyst may also be applied in a mixed form.

According to the first aspect, the present invention provides a catalytic article for treating an exhaust stream, which comprises
a first catalyst containing a vanadium component and an antimony component, and
a second catalyst containing a precious metal component.

### <First Catalyst>

The first catalyst may be a vanadium-based SCR catalyst containing a vanadium component and an antimony component. The vanadium component and the antimony component may be present in form of respective oxides and/or composite oxide thereof, which are supported on particles of a support.

Particularly, the vanadium component and the antimony component may be present in the first catalyst in form of vanadium oxide such as V₂O₅ and antimony oxide such as Sb₂O₃. In this case, there may also be a composite oxide of vanadium and antimony in the first catalyst. Accordingly, the first catalyst may contain a vanadium oxide, an antimony oxide and optionally a composite oxide of vanadium and antimony, which are supported on particles of a support, as the vanadium component and the antimony component.

It can also be contemplated that the vanadium component and the antimony component may be present in the first catalyst only in form of a composite oxide of vanadium and antimony.

The first catalyst may optionally contain at least one additional metal or metalloid. Examples of the additional metal or metalloid may include but are not limited to boron (B), aluminum (Al), bismuth (Bi), silicon (Si), tin (Sn), lead (Pb), chromium (Cr), manganese (Mn), iron (Fe), cobalt (Co), nickel (Ni), copper (Cu), zinc (Zn), gallium (Ga), cerium (Ce), yttrium (Y), niobium (Nb), molybdenum (Mo), barium (Ba), samarium (Sm), erbium (Er) and tungsten (W).

Particularly, the additional metal or metalloid may be selected from silicon (Si), molybdenum (Mo) and tungsten (W). It will be understood that the at least one additional metal or metalloid may be present in form of respective oxides, or a composite oxide thereof with vanadium, antimony or other additional metal or metalloid, or a combination thereof.

In some embodiments, the first catalyst contains or consists of a vanadium oxide, an antimony oxide and optionally at least one oxide of metal or metalloid selected from silicon (Si), molybdenum (Mo) and tungsten (W), on particles of a support. For example, the first catalyst contains or consists of respective and/or composite oxides of vanadium (V), antimony (Sb) and silicon (Si) on particles of a support.

Useful materials as the support for vanadium, antimony and optionally the additional metal or metalloid in the first catalyst may include, but are not limited to molecular sieves and oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn and Bi. Preferably, the support may be one or more selected from titania (preferably anatase), silica, alumina, zirconia, and any dopant-stabilized forms thereof.

The first catalyst may contain the vanadium component, calculated as V₂O₅, in an amount of 0.5 to 8% by weight or 1 to 6% by weight, based on the total weight of the first catalyst.

The first catalyst may contain the antimony component, calculated as Sb₂O₃, in an amount of 0.5 to 16% by weight or 2 to 9% by weight, based on the total weight of the first catalyst.

Each of the at least one additional metal or metalloid, when present, may be contained in the first catalyst in an amount of 0.1 to 30% by weight, 1 to 15% by weight, or 2 to 10% by weight, calculated as respective oxides, based on the total weight of the first catalyst.

The support may be contained in the first catalyst in an amount of at least 45% by weight, at least 60% by weight, at least 70% by weight or at least 75% by weight, based on the total weight of the first catalyst. The amount of the support may be up to 95% by weight or up to 90% by weight, based on the total weight of the first catalyst.

In some embodiments, the first catalyst contains or consists of
(a) 0.5 to 8% by weight of a vanadium oxide, calculated as V₂O₅,
(b) 0.5 to 16% by weight of an antimony oxide, calculated as Sb₂O₃,
(c) 1 to 15% by weight of SiO₂, and
(e) 70 to 95% by weight of TiO₂,
each being based on the total weight of the first catalyst.

In some further embodiments, the first catalyst contains or consists of
(a) 1 to 6% by weight of a vanadium oxide, calculated as V₂O₅,
(b) 2 to 9% by weight of an antimony oxide, calculated as Sb₂O₃,
(c) 2 to 10% by weight of SiO₂,
(e) 75 to 95% by weight of TiO₂,
each being based on the total weight of the first catalyst.

The total weight of the first catalyst in each case as described herein will be 100% by weight.

### <Second Catalyst>

The second catalyst may be a precious metal based oxidation catalyst containing a precious metal component, preferably a platinum group metal component. The precious metal component may contain one or more selected from ruthenium, rhodium, iridium, palladium, platinum, silver and gold, on particles of a support. Preferably, the precious metal component contains one or more selected from ruthenium, rhodium, iridium, palladium and platinum, more preferably palladium and platinum, most preferably platinum, on particles of a support.

It will be understood that the precious metal may be present in any possible valence state, for example respective metals or metal oxides as the catalytically active form, or may be for example respective metal compounds, complexes and the like, which will decompose or otherwise convert to the catalytically active form upon calcination or use of the catalyst.

Useful materials as the support for the precious metal in the second catalyst may be any materials suitable for receiving and carrying precious metals, for example molecular sieves, oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn, Sm, Eu, Hf, and Bi. Particularly, the support for the precious metal may be selected from high surface area alumina, silica, titania, ceria, zirconia, lanthana, baria, yttria, neodymia, praseodymia, titania, europia, samaria, hafnia, and any composite or combination thereof. An exemplary support may be a composite oxide of silica and alumina, silica and titania, and the like.

Optionally, the second catalyst may further contain a zeolitic or non-zeolitic molecular sieve component. Molecular sieves refer to framework materials based on an extensive three-dimensional network of oxygen ions containing generally tetrahedral type sites and having a substantially uniform pore distribution. Suitable molecular sieves for the purpose of the present invention may be microporous or mesoporous.

Particularly, the molecular sieves may be zeolites, which is optionally metal-promoted. Herein, the term “metal-promoted” within the context of the molecular sieve is intended to mean a metal capable of improving any performance of the zeolite has been incorporated into and/or onto the zeolite.

Preferably, suitable molecular sieves may include, but are not limited to aluminosilicate zeolites having a framework type selected from the group consisting of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN. More preferably, the molecular sieves include zeolites having a framework type selected from the group AEI, BEA (e.g., beta), CHA (e.g., chabazite, SSZ-13), AFT, AFX, FAU (e.g., zeolite Y), MOR, MFI (e.g., ZSM-5), MOR (e.g., mordenite) and MEL, among which AEI, BEA and CHA are particularly preferred.

It will be appreciated that when a zeolite is mentioned by reference to the framework type code as generally accepted by the International Zeolite Association (IZA) herein, it is intended to include not only the reference material but also any isotypic framework materials having SCR catalytic activities. The list of reference material and the isotypic framework materials for each framework type code are available from the database of IZA (http://www.iza-structure.org/databases/).

In some embodiments, the second catalyst contains a metal-promoted molecular sieve. The promoter metal may be selected from precious metals such as Au and Ag, platinum group metals such as Ru, Rh, Pd, In and Pt, base metals such as Cr, Zr, Nb, Mo, Fe, Mn, W, V, Al, Ti, Co, Ni, Cu, Zn, Sb, Sn and Bi, alkali earth metals such as Ca and Mg, and any combinations thereof. The promoter metal is preferably Fe or Cu or a combination thereof.

In some illustrative embodiments, the second catalyst contains Cu and/or Fe promoted zeolite having the framework type of AEI, BEA, CHA, AFT, AFX, FAU, FER, KFI, MOR, MFI, MOR or MEL, particularly Cu and/or Fe promoted zeolite having the framework of AEI, BEA or CHA.

The promoter metal may be present in the metal-promoted molecular sieve in an amount of 0.1 to 20% by weight, or 0.5 to 15% by weight, or 1 to 10% by weight, or 2 to 6% by weight on an oxide basis, based on the total weight of metal-promoted molecular sieve. In some illustrative embodiments wherein Cu or Fe is used as the promoter metal, the promoter metal is preferably present in an amount of 0.5 to 15% by weight, or 1 to 15% by weight, or 1 to 10% by weight, on an oxide basis, based on the total weight of the metal-promoted molecular sieve.

The precious metal component and the molecular sieve component as described for the second catalyst may be present in any possible forms, for example as a physical mixture thereof, or in separate forms. Alternatively, the precious metal component may be integrated, for example by distributing the precious metal component on the external surface or in the channels, cavities, or cages of the molecular sieve.

In some embodiments, the catalytic article according to the present invention may comprise a substrate.

### <Substrate>

The term “substrate” as used herein generally refers to a structure that is suitable for withstanding conditions encountered in an exhaust stream, on which a catalytic material is carried, in the form of a coating, typically a washcoat. The substrate may have an inlet end and an outlet end which define an axial length thereof and a plurality of fine, parallel gas flow passages extending along the axial length.

The substrate is usually inert and conventionally made of, for example, ceramic or metal materials, which is also known as “inert substrate”. The substrate may alternatively be active, and may consist of, for example, extrudate containing catalytically active species.

The substrate may be a monolithic flow-through structure, which has a plurality of fine, parallel gas flow passages extending from an inlet to an outlet end of the substrate such that passages are open to fluid flow therethrough. The passages, which are essentially straight paths from their fluid inlet to their fluid outlet, are defined by walls on which the catalytic material is applied as washcoats so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain 50 to 900 or more flow passages (or “cells”) per square inch of cross section. For example, the substrate may have 50 to 600 cells per square inch (“cpsi”) or 200 to 450 cpsi. The wall thickness of flow-through substrates may vary, with a typical range from 2 mils to 0.1 inches.

The substrate may also a monolithic wall-flow structure having a plurality of fine, parallel gas flow passages extending along from an inlet to an outlet end of the substrate wherein alternate passages are blocked at opposite ends. The passages are defined by walls on which the catalytic material is applied as washcoats so that the gases flowing through the passages contact the catalytic material. The configuration requires the gases flow through the porous walls of the wall-flow substrate to reach the outlet end. The wall-flow substrates may have up to 700 cpsi, for example 100 to 400 cpsi. The flow passages of the monolithic substrate are thin-walled channels, which can be of any suitable cross-sectional shape and size such as trapezoidal, rectangular, square, sinusoidal, hexagonal, oval, circular, etc. The wall thickness of wall-flow substrates may vary, with a typical range from 2 mils to 0.1 inches.

The term “washcoat” has its usual meaning in the art and refers to a thin, adherent coating of a catalytic or other material applied to a substrate. A washcoat is generally formed by preparing a slurry containing the desired material and optionally processing aids such as binder with a certain solid content (e.g., 15 to 60% by weight) and then applying the slurry onto a substrate, dried and calcined to provide a washcoat layer. The washcoat, in form of one or more layers, is generally loaded on the substrate in an amount of 0.1 to 10 g/in³, for example 0.5 to 7 g/in³.

### <Catalytic Article Configuration>

In the catalytic article according to the present invention, the first catalyst and the second catalyst may be comprised in any suitable configurations, without any particular restriction. Suitable configurations are known in the art, for example those conventional configurations of AMOx catalytic articles comprising an SCR catalyst component and an oxidation catalyst component.

For example, the first catalyst and the second catalyst may be comprised in the catalytic article according to the present invention in a mixed form. In some embodiments, the catalytic article comprises a substrate, on which a coating layer comprising the first catalyst and the second catalyst is carried.

The first catalyst and the second catalyst may also be comprised in the catalytic article according to the present invention in a separate form. For example, the first catalyst may be comprised in an extrudate as a substrate and the second catalyst may be comprised as a layer on the extrudate. Accordingly, in some embodiments, the catalytic article comprises an extrudate comprising the first catalyst as a substrate, on which the second catalyst is carried as a coating layer.

The term “extrudate” as used herein generally refers to a shaped body formed by extrusion. The extrudate may have any suitable structures allowing gases flow through, preferably honeycomb structure. The honeycomb structure may have flow passages as described for the monolithic flow-through and wall-flow structures hereinbelow.

Alternatively, the first catalyst and the second catalyst may be comprised in the catalytic article according to the present invention in respective regions. In this case, the catalytic article will have a zoned configuration. In some embodiments, the catalytic article comprises a substrate, on which a coating comprising the first catalyst is carried and extended from one end (for example the inlet end) toward to the opposite end of the substrate over partial axial length of the substrate, and a coating comprising the second catalyst is carried and extended from said opposite end (for example the outlet end) over at least partial axial length of the substrate. The coating comprising the first catalyst and the coating comprising the second catalyst may be adjacent to or overlapping each other. It can be contemplated that the catalytic article may comprise two or more pieces of substrate, and the first catalyst and the second catalyst are carried on respective substrates.

Further, the first catalyst and the second catalyst may be comprised in the catalytic article according to the present invention in respective coating layers. In this case, the catalytic article will have a layered configuration, which comprises a first coating layer comprising the first catalyst and a second coating layer comprising the second catalyst. In some embodiments, the catalytic article comprises a substrate, on which a first coating layer comprising the first catalyst and a second coating layer comprising the second catalyst are carried. The first coating layer may overlap, superpose or cover the second coating layer. Particularly, the first coating may be at least partially on top of the second coating or under the second coating, preferably at least partially on top of the second coating. Preferably, the second coating layer extends from the outlet end toward the inlet end over at least partial axial length of the substrate.

In some illustrative embodiments, the catalytic article according to the present invention comprises
a substrate,
a first coating layer comprising the first catalyst, and
a second coating layer comprising the second catalyst,
   wherein the first coating layer is on top of and covers the second coating layer.

In some further illustrative embodiments, the catalytic article according to the present invention comprises
a substrate,
a first coating layer comprising the first catalyst, and
a second coating layer comprising the second catalyst,
   wherein the first coating layer is on top of and covers the second coating layer, and wherein the first coating layer and the second coating layer both extend entire axial length of the substrate.

Any of the coating layers comprising the first catalyst and/or the second catalyst or the extrudate comprising the first catalyst as described herein may also comprise one or more components in addition to the catalysts, which may be non-catalytically active components, for example processing aids useful in the preparation of catalytic articles, such as lubricants and binders. The other components may also be catalytically active, for example active species other than those catalysts as described herein.

The first catalyst may be present in an amount providing 0.005 to 1.5 g/in³ of vanadium, 0.01 to 1.0 g/in³ or 0.03 to 0.5 g/in³ of vanadium, calculated as V₂O₅, based on the substrate or substrate region comprising or carrying the first catalyst.

Additionally or alternatively, the first catalyst may be present in an amount providing 0.005 to 2.5 g/in³ of antimony, 0.01 to 1.5 g/in³ or 0.02 to 1.2 g/in³ of antimony, calculated as Sb₂O₃, based on the substrate or substrate region comprising or carrying the first catalyst.

The precious metal component may be present in an amount of 0.01 to 20 g/ft³, preferably 0.5 to 10 g/ft³, calculated as respective precious metal, based on the substrate or substrate region carrying the second catalyst.

The first catalyst and the second catalyst may be comprised in a weight ratio in the range of 50:1 to 0.5:1, 30:1 to 1:1 or 20:1 to 5:1, based on the weights of these components.

The catalytic article according to the present invention may be used to treat exhaust streams from combustion engines of automobiles, especially diesel engines. The catalytic article according to the present invention may particularly be effective to treat exhaust streams from heavy-duty diesel engines, including on-road and off-road heavy-duty diesel engines.

Accordingly, in the second aspect, the present invention relates to a system for treating an exhaust stream, especially originating from heavy-duty diesel engines, including on-road and off-road heavy-duty diesel engines, which comprises a reductant source (e.g., NH₃ or a precursor thereof) and the catalytic article as described in the first aspect hereinabove.

The system for treating an exhaust stream, may further comprise one or more exhaust stream treatment elements. Conventional exhaust stream treatment elements include, but are not limited to diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

In some embodiments, the system for treating an exhaust stream further comprises a diesel oxidation catalyst (DOC) and a selective catalytic reduction (SCR) catalyst located downstream of the engine and upstream of the catalytic article as described in the first aspect hereinabove. Preferably, the system for treating an exhaust stream further comprises a diesel oxidation catalyst (DOC), a selective catalytic reduction (SCR) catalyst and a catalyzed soot filter (CSF) located upstream of the catalytic article as described in the first aspect hereinabove.

In the third aspect, the present invention relates to a method for treatment of an exhaust stream containing nitrogen oxides, which comprises contacting the exhaust stream with the catalytic article as described in the first aspect or passing the exhaust stream through the system as described in the second aspect, in the presence of NH₃ as a reductant.

In some embodiments, the method is useful for treatment of an exhaust stream originating from diesel engines, especially heavy-duty diesel engines, for example on-road and off-road heavy-duty diesel engines.

In the fourth aspect, the present invention relates to a method for alleviating poisoning of a precious metal component in a catalytic article comprising a vanadium-based catalyst and a precious metal based catalyst, which comprises incorporating an antimony component in the vanadium-based catalyst. The vanadium-based catalyst is as described hereinabove for the first catalyst.

In some embodiments, the vanadium-based catalyst may contain a vanadium component, calculated as V₂O₅, in an amount of 0.5 to 8% by weight or 1 to 6% by weight, based on the total weight of the vanadium-based catalyst. Alternatively or additionally, the vanadium-based catalyst may contain the antimony component, calculated as Sb₂O₃, in an amount of 0.5 to 16% by weight or 2 to 9% by weight, based on the total weight of the vanadium-based catalyst.

### EMBODIMENTS

Various embodiments are listed below. It will be understood that the embodiments listed below may be combined with all aspects and other embodiments in accordance with the scope of the invention.

1. A catalytic article for treating an exhaust stream, comprising
a first catalyst containing a vanadium component and an antimony component, and
a second catalyst containing a precious metal component.

2. The catalytic article according to Embodiment 1, wherein the first catalyst is comprised in an extrudate as a substrate, on which the second catalyst is carried as a coating layer.

3. The catalytic article according to Embodiment 1, comprising a substrate having an inlet end and an outlet end which define an axial length thereof and a plurality of fine, parallel gas flow passages extending along the axial length, preferably a flow-through substrate or a wall-flow substrate.

4. The catalytic article according to Embodiment 3, which comprises on the substrate a coating layer comprising the first catalyst and the second catalyst.

5. The catalytic article according to Embodiment 3, which comprises on the substrate a coating comprising the first catalyst carried and extended from one end toward to the opposite end over partial axial length of the substrate, and a coating comprising the second catalyst carried and extended from said opposite end over at least partial axial length of the substrate, and the two coating are adjacent to or overlapping each other.

6. The catalytic article according to Embodiment 3, which comprises on the substrate a first coating layer comprising the first catalyst and a second coating layer comprising the second catalyst.

7. The catalytic article according to Embodiment 6, wherein the first coating layer is at least partially on top of the second coating or under the second coating, preferably at least partially on top of the second coating.

8. The catalytic article according to Embodiment 6 or 7, wherein the second coating layer extends from the outlet end toward the inlet end over at least partial axial length of the substrate.

9. The catalytic article according to any of Embodiments 6 to 8, wherein the first coating layer overlaps, superposes or covers the second coating layer.

10. The catalytic article according to Embodiment 9, which comprises
a substrate,
a first coating layer comprising the first catalyst, and
a second coating layer comprising the second catalyst, wherein the first coating layer is on top of and covers the second coating layer.

11. The catalytic article according to Embodiment 10, wherein the first coating layer and the second coating layer both extend entire axial length of the substrate.

12. The catalytic article according to any of Embodiments 1 to 11, wherein the first catalyst contains the vanadium component, calculated as V₂O₅, in an amount of 0.5 to 8% by weight or 1 to 6% by weight, based on the total weight of the first catalyst.

13. The catalytic article according to any of Embodiments 1 to 12, wherein the first catalyst contains the antimony component, calculated as Sb₂O₃, in an amount of 0.5 to 16% by weight or 2 to 9% by weight, based on the total weight of the first catalyst.

14. The catalytic article according to any of Embodiments 1 to 13, wherein the first catalyst contains a vanadium oxide, an antimony oxide and optionally a composite oxide of vanadium and antimony, which are supported on particles of a support.

15. The catalytic article according to Embodiment 14, wherein the support includes one or more of molecular sieves and oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn and Bi.

16. The catalytic article according to any of Embodiments 1 to 15, wherein the precious metal component contains one or more selected from ruthenium, rhodium, iridium, palladium and platinum, more preferably palladium and platinum, most preferably platinum, which are supported on particles of a support.

17. The catalytic article according to Embodiment 16, wherein the support in the precious metal component is one or more of molecular sieves and oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn, Sm, Eu, Hf, and Bi.

18. The catalytic article according to any of Embodiments 1 to 17, wherein the second catalyst contains a zeolitic or non-zeolitic molecular sieve component.

19. The catalyst article according to any of Embodiments 1 to 18, wherein the precious metal component is present in an amount of 0.01 to 20 g/ft³, preferably 0.5 to 10 g/ft³, calculated as each precious metal.

20. The catalytic article according to any of Embodiments 1 to 19, wherein the first catalyst and the second catalyst may be comprised in a weight ratio in the range of 50:1 to 0.5:1, 30:1 to 1:1, or 20:1 to 5:1.

21. A system for treating an exhaust stream, which comprises a reductant source (e.g., NH₃ or a precursor thereof), the catalytic article according to any of preceding Embodiments, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

22. The system according to Embodiment 21, wherein the exhaust stream originates from an internal combustion engine, especially a diesel engine.

23. A method for treatment of an exhaust stream containing nitrogen oxides, which comprises contacting the exhaust stream with the catalytic article as defined in any of Embodiments 1 to 20 or passing the exhaust stream through the system as defined in any of Embodiment 21 or 22, in the presence of NH₃ as a reductant.

24. A method for alleviating poisoning of a precious metal component in a catalytic article comprising a vanadium-based catalyst and a precious metal based catalyst, which comprises incorporating an antimony component in the vanadium-based catalyst.

25. The method according to Embodiment 24, wherein the vanadium-based catalyst contains a vanadium component, calculated as V₂O₅, in an amount of 0.5 to 8% by weight or 1 to 6% by weight, based on the total weight of the vanadium-based catalyst.

26. The method according to Embodiment 24 to 25, wherein the vanadium-based catalyst contains the antimony component, calculated as Sb₂O₃, in an amount of 0.5 to 16% by weight or 2 to 9% by weight, based on the total weight of the vanadium-based catalyst.

The invention will be further illustrated by following Examples, which set forth particularly advantageous embodiments. While the Examples are provided to illustrate the present invention, they are not intended to limit it.

### EXAMPLES

### Example 1

### Step 1.1 Applying a Bottom Washcoat Comprising a Pt Based Catalyst on a Substrate

A Cu-CHA slurry was prepared by mixing 218.7 g of a Cu-CHA zeolite from Zeolyst and 6.2 g of Al₂O₃ powder into 300 g of deionized (DI) water, wherein the Cu-CHA zeolite has a SiO₂ to Al₂O₃ molar ratio of 28, CuO weight content of 3.2%, X-ray crystallinity of 98%, BET surface area of 750 m²/g and D₉₀ of 5 microns.

A Pt slurry was prepared by mixing 45.6 g of colloidal Pt solution having a Pt content of 2 wt % with 100 g of DI water to form a uniform mixture, which was impregnated to 207 g of 8% SiO₂ doped TiO₂ powder and stirred for 30 min, adjusted to pH of 4 with tartaric acid, and then milled to a particle size of D₉₀ of 5 microns, as measured with a Sympatec particle size analyzer.

The Cu-CHA slurry and Pt slurry were mixed, adjusted to pH of 4 with tartaric acid and then stirred for 20 minutes, to obtain a homogenous slurry. The obtained slurry was coated onto a flow-through cordierite monolith substrate of 300 cpsi with a wall thickness of 5 mils by dipping the substrate into the slurry. Extra loaded slurry was blown off with an air knife carefully, followed by drying at 130° C. and calcination at 550° C. After cooling to room temperature, the process of dipping, drying and calcining was repeated until a total washcoat loading of 0.5 g/in³ on the substrate was obtained, wherein the Cu-CHA loading is 0.25 g/in³, Pt loading is 2 g/ft³.

### Step 1.2 Applying a Top Washcoat Comprising a V/Sb Based Catalyst

140.6 g of TiO₂ in anatase form having a titanium content of 95.9 wt % calculated as TiO₂, 28.6 g of vanadyl oxalate solution having a vanadium content of 10.8 wt % calculated as V₂O₅, and 4.5 g of Sb₂O₃ were mixed in 200 g of DI water at room temperature. After stirring the obtained suspension for 30 minutes, a 25% aqueous ammonia solution was used to adjust the pH to 7.0. Then 25.5 g of SiO₂ sol having a SiO₂ content of 30.1 wt % was added. After stirring for 1 hour, a homogenous slurry for the V/Sb based catalyst was obtained, into which the substrate with a bottom washcoat as obtained from Step 1.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 3.0 g/in³ was obtained. The V/Sb based catalyst has a vanadium content of 2.0 wt %, calculated as V₂O₅, based on the total weight of V/Sb based catalyst.

### Example 2

### Step 2.1 Applying a Bottom Washcoat Comprising a Pt Based Catalyst on a Substrate

The procedure according to the above Step 1.1 was repeated to provide a substrate with a bottom washcoat.

### Step 2.2 Applying a Top Washcoat Comprising a V/Sb Based Catalyst

132.8 g of TiO₂ in anatase form having a titanium content of 95.9 wt % calculated as TiO₂, 57.1 g of vanadyl oxalate solution having a vanadium content of 10.8 wt % calculated as V₂O₅, and 9.0 g of Sb₂O₃ were mixed in 200 g of DI water at room temperature. After stirring the obtained suspension for 30 minutes, a 25% aqueous ammonia solution was further added to raise the system pH to 7.0. Then 25.5 g of SiO₂ sol having a SiO₂ content of 30.1 wt % was added. After stirring for 1 hour, a homogenous slurry for the V/Sb based catalyst was obtained, into which the substrate with a bottom washcoat as obtained from Step 2.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading of 3.0 g/in³ on the substrate was obtained. The V/Sb based catalyst has a vanadium content of 4.0 wt %, calculated as V₂O₅, based on the total weight of V/Sb based catalyst.

### Example 3

### Step 3.1 Applying a Bottom Washcoat Comprising a Pt Based Catalyst on a Substrate

The procedure according to the above Step 1.1 was repeated to provide a substrate with a bottom washcoat.

### Step 3.2 Applying a Top Washcoat Comprising a V/Sb Based Catalyst

125.0 g of TiO₂ in anatase form having a titanium content of 95.9 wt % calculated as TiO₂, 85.7 g of vanadyl oxalate solution having a vanadium content of 10.8 wt % calculated as V₂O₅, and 13.5 g of Sb₂O₃ were mixed in 200 g of DI water at room temperature. After stirring the obtained suspension for 30 minutes, a 25% aqueous ammonia solution was further added to raise the system pH to 7.0. Then 25.5 g of SiO₂ sol having a SiO₂ content of 30.1 wt % was added. After stirring for 1 hour, a homogenous slurry for the V/Sb based catalyst was obtained, into which the substrate with a bottom washcoat as obtained from Step 3.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 3.0 g/in³ was obtained. The V/Sb based catalyst has a vanadium content of 6.0 wt %, calculated as V₂O₅, based on the total weight of V/Sb based catalyst.

### Example 4 (Comparative)

### Step 4.1 Applying a Bottom Washcoat Comprising a Pt Based Catalyst on a Substrate

The procedure according to the above Step 1.1 was repeated to provide a substrate with a bottom washcoat.

Step 4.2 Applying a Top Washcoat Comprising a V/W Based Catalyst 147.4 g of WO₃ doped TiO₂ having a solid content of 95.0 wt % including 10 wt % WO₃ and 28.6 g of vanadyl oxalate solution having a vanadium content of 10.8 wt % calculated as V₂O₅ were mixed in 200 g of DI water at room temperature. After stirring the obtained suspension for 30 minutes, a 25% aqueous ammonia solution was further added to raise the system pH to 7.0. Then 17.3 g of SiO₂ sol having a SiO₂ content of 40.0 wt % was added. After stirring for 1 hour, a homogenous slurry for the V/W based catalyst was obtained, into which the substrate with a bottom washcoat as obtained from Step 4.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 3.0 g/in³ was obtained. The V/W based catalyst has a vanadium content of 2.0 wt %, calculated as V₂O₅, based on the total weight of V/Sb based catalyst.

### Example 5 (Comparative)

### Step 5.1 Applying a Bottom Washcoat Comprising a Pt Based Catalyst on a Substrate

The procedure according to the above Step 1.1 was repeated to provide a substrate with a bottom washcoat.

### Step 5.2 Applying a Top Washcoat Comprising a V/W Based Catalyst

144.3 g of WOs doped TiO₂ having a solid content of 95.0 wt % including 10 wt % WO₃ and 57.1 g of vanadyl oxalate solution having a vanadium content of 10.8 wt % calculated as V₂O₅ were mixed in 200 g of DI water at room temperature. After stirring the obtained suspension for 30 minutes, a 25% aqueous ammonia solution was further added to raise the system pH to 7.0. Then 17.3 g of SiO₂ sol having a SiO₂ content of 40.0 wt % was added. After stirring for 1 hour, a homogenous slurry for the V/W based catalyst was obtained, into which the substrate with a bottom washcoat as obtained from step 5.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 3.0 g/in³ was obtained. The V/W based catalyst has a vanadium content of 4.0 wt %, calculated as V₂O₅, based on the total weight of V/Sb based catalyst.

### Example 6 (Comparative)

### Step 6.1 Applying a Bottom Washcoat Comprising a Pt Based Catalyst on a Substrate

The procedure according to the above Step 1.1 was repeated to provide a substrate with a bottom washcoat.

### Step 6.2 Applying a Top Washcoat Comprising a V/W Based Catalyst

141.1 g of WO₃ doped TiO₂ having a solid content of 95.0 wt % including 10 wt % WO₃ and 85.7 g of vanadyl oxalate solution having a vanadium content of 10.8 wt % calculated as V₂O₅ were mixed in 200 g of DI water at room temperature. After stirring the obtained suspension for 30 minutes, a 25% aqueous ammonia solution was further added to raise the system pH to 7.0. Then 17.3 g of SiO₂ sol having a SiO₂ content of 40.0 wt % was added. After stirring for 1 hour, a homogenous slurry for the V/W based catalyst was obtained, into which the substrate with a bottom washcoat as obtained from step 6.1 was dipped to load enough slurry. Extra loaded slurry was blown off with an air knife carefully, followed by drying with hot air at 150° C. for 15 minutes and then calcining at 450° C. for 1 hour in air.

The process of dipping, drying and calcining was repeated until a total washcoat loading on the substrate of 3.0 g/in³ was obtained. The V/W based catalyst has a vanadium content of 6.0 wt %, calculated as V₂O₅, based on the total weight of V/Sb based catalyst.

### Performance Test

Cores having a diameter of 1 inch and a length of 3 inches were cut from the fresh and aged catalytic articles from each Examples as the test samples, and placed in a fixed lab simulator for testing.

The aged test samples were prepared by hydrothermally treating the catalytic articles as prepared in each Examples in 10 vol % water/air at 550° C. for 100 hours.

The feed gas contains, by volume, 500 ppm NH₃, 7% H₂O, 10% 02, 8% CO₂ and the balance of N₂. The test was conducted at a gas space velocity of 100,000 h⁻¹ and at a temperature as shown in Table 1.

The results for NH₃ conversion and testing temperatures are listed in Table 1.

TABLE 1

NH₃ Conversion, %

| Samples | 250° C. | 300° C. | State |
|---|---|---|---|
| Example 1 | 90 | 97 | Fresh |
| | 84 | 96 | Aged |
| Example 2 | n.d. | n.d. | Fresh |
| | 17 | 38 | Aged |
| Example 3 | n.d. | n.d. | Fresh |
| | 13 | 23 | Aged |
| Example 4 | 23 | 94 | Fresh |
| (Comparative) | 14 | 62 | Aged |
| Example 5 | 0 | 70 | Fresh |
| (Comparative) | 0 | 16 | Aged |
| Example 6 | 0 | 37 | Fresh |
| (Comparative) | 0 | 0 | Aged |

n.d.: not determined

As can be seen, the catalytic articles comprising vanadium and antimony components according to the present invention had a retained NH₃ conversion performance upon aging, while the comparative counterparts i.e., the catalytic articles comprising vanadium and tungsten components, exhibited significantly lower NH₃ conversion or even no NH₃ conversion in case of 6 wt % vanadium content which was resulted from severer platinum poisoning by vanadium.

1-26. (canceled)

27. A catalytic article for treating an exhaust stream, comprising:
a first catalyst containing a vanadium component and an antimony component, and
a second catalyst containing a precious metal component.

28. The catalytic article according to claim 27, wherein the first catalyst is comprised in an extrudate as a substrate, on which the second catalyst is carried as a coating layer.

29. The catalytic article according to claim 27, comprising a substrate having an inlet end and an outlet end which define an axial length thereof and a plurality of fine, parallel gas flow passages extending along the axial length, preferably a flow-through substrate or a wall-flow substrate.

30. The catalytic article according to claim 29, which comprises on the substrate a coating layer comprising the first catalyst and the second catalyst.

31. The catalytic article according to claim 29, which comprises on the substrate a coating comprising the first catalyst carried and extended from one end toward to the opposite end over partial axial length of the substrate, and a coating comprising the second catalyst carried and extended from said opposite end over at least partial axial length of the substrate, and the two coating are adjacent to or overlapping each other.

32. The catalytic article according to claim 29, which comprises on the substrate a first coating layer comprising the first catalyst and a second coating layer comprising the second catalyst.

33. The catalytic article according to claim 32, wherein the second coating layer extends from the outlet end toward the inlet end over at least partial axial length of the substrate.

34. The catalytic article according to claim 23, wherein the first coating layer overlaps, superposes or covers the second coating layer.

35. The catalytic article according to claim 34, which comprises
a substrate,
a first coating layer comprising the first catalyst, and
a second coating layer comprising the second catalyst,
wherein the first coating layer is on top of and covers the second coating layer.

36. The catalytic article according to claim 35, wherein the first coating layer and the second coating layer both extend entire axial length of the substrate.

37. The catalytic article according to claim 27, wherein the first catalyst contains the vanadium component, calculated as V₂O₅, in an amount of 0.5 to 8% by weight or 1 to 6% by weight, based on the total weight of the first catalyst.

38. The catalytic article according to claim 27, wherein the first catalyst contains the antimony component, calculated as Sb₂O₃, in an amount of 0.5 to 16% by weight or 2 to 9% by weight, based on the total weight of the first catalyst.

39. The catalytic article according to claim 27, wherein the first catalyst contains a vanadium oxide, an antimony oxide and optionally a composite oxide of vanadium and antimony, which are supported on particles of a support.

40. The catalytic article according to claim 27, wherein the precious metal component contains one or more selected from ruthenium, rhodium, iridium, palladium and platinum, more preferably palladium and platinum, most preferably platinum, which are supported on particles of a support.

41. The catalytic article according to claim 27, wherein the second catalyst contains a zeolitic or non-zeolitic molecular sieve component.

42. The catalyst article according to claim 27, wherein the precious metal component is present in an amount of 0.01 to 20 g/ft³ calculated as each precious metal.

43. The catalytic article according to claim 27, wherein the first catalyst and the second catalyst may be comprised in a weight ratio in the range of 50:1 to 0.5:1, 30:1 to 1:1, or 20:1 to 5:1.

44. A system for treating an exhaust stream, which comprises a reductant source (e.g., NH₃ or a precursor thereof), the catalytic article according to claim 27, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

45. A method for treatment of an exhaust stream containing nitrogen oxides, which comprises contacting the exhaust stream with the catalytic article as defined in claim 1 or passing the exhaust stream through A system for treating an exhaust stream, which comprises a reductant source (e.g., NH₃ or a precursor thereof), the catalytic article, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer, in the presence of NH₃ as a reductant.

46. A method for alleviating poisoning of a precious metal component in a catalytic article comprising a vanadium-based catalyst and a precious metal based catalyst, which comprises incorporating an antimony component in the vanadium-based catalyst.
